(19) United States
(12) Patent Application Publication
(10) Pub. No.: US 2004/0049301 A1
(43) Pub. Date: Mar. 11, 2004

(54) Apparatus and method for preparing and supplying slurry for CMP machine

(75) Inventor: Masato Kawasaki, Okayama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: m FSI LTD., Tokyo (JP)

(21) Appl. No.: 10/654,891

(22) Filed: Sep. 5, 2003

(30) Foreign Application Priority Data
Sep. 10, 2002 (JP) 2002-263738

(51) Int. Cl. G05B 13/02; G05B 11/32; G05B 21/02; G05B 21/00

(52) U.S. Cl. 700/68; 700/73; 700/74; 700/46; 700/265; 700/266

(57) ABSTRACT

Disclosed is an apparatus for preparing and supplying a slurry to a chemical mechanical polishing machine. The slurry contains liquid components at a predetermined mixing ratio. The apparatus includes draw ports for separately drawing therethrough the liquid components, and a discharge port for supplying the slurry to the machine. Feed pumps are arranged on feed lines for the liquid components, respectively, said feed lines extending from the individual draw ports to the discharge port, such that the feed pumps can draw the corresponding liquid components in specific amounts to give the mixing ratio and can deliver the thus-drawn liquid components toward the discharge port, respectively. Dampers and pressurization valves are arranged in combinations on the respective feed lines on delivery sides of the feed pumps. Flowmeters are arranged on downstream sides of the corresponding combinations of the dampers and pressurization valves. The apparatus is also provided with a programmable logic controller for controlling delivery rates of the individual feed pumps by using measurement values from the flowmeters. A slurry preparing and supplying method making use of a plurality of such apparatuses is also disclosed.

### FIELD OF THE INVENTION

This invention relates to an apparatus for mixing at least a dispersion of fine abrasive particles and a solution of one or more additives at a predetermined ratio to prepare a slurry and supplying the slurry to a chemical mechanical polishing machine (hereinafter called “CMP machine”) which is adapted to polish and planarize with high accuracy the surfaces of substrates such as wafers, and also to a slurry preparing and supplying method making use of the apparatus.

### DESCRIPTION OF THE BACKGROUND

Keeping in step with a move toward LSIs of higher integration and higher performance in recent years, chemical mechanical polishing (CMP) is attracting attention as a working method for planarizing with high accuracy the surfaces of substrates such as wafers. Employed in CMP is a slurry prepared by mixing a dispersion of fine abrasive particles (hereinafter called “concentrated slurry”) with a solution of additives (hereinafter called “additives solution”). The concentrated slurry contains a polishing abrasive, which is composed of fine particles of silica, alumina, zirconia, manganese dioxide or ceria (cerium oxide), in a form dispersed in an aqueous alkaline solution of potassium hydroxide, ammonia or the like or in a water containing a surfactant. The additives solution, on the other hand, contains various additives selected depending on the work to be polished, such as a surfactant and an oxidizing agent for promoting chemical action such as hydrogen peroxide or ferric nitrate. Therefore, the slurry is a solution with the polishing abrasive and additives mixed and dispersed therein, and is used in actual polishing. Excellent polishing is achieved by a combination of chemical action, which occurs between the additives solution in the slurry and each substrate, and mechanical action between the polishing abrasive in the slurry and the substrate.

When polishing, for example, a silicon dioxide film (oxide film) of an interlayer insulation material on a semiconductor silicon substrate by a CMP machine, a slurry is used with a concentrated slurry of silica particles diluted in an aqueous alkaline solution, for example, an aqueous solution of potassium hydroxide added to improve the dispersibility of the silica particles and also to form a particle agglomeration state optimal for the polishing. The slurry is fed onto the semiconductor silicon substrate mounted on the CMP machine, and the oxide film is removed by mechanical polishing between the silica particles in the slurry and a polishing pad of the CMP machine.

When polishing a tungsten metal film formed as an interconnecting material on a semiconductor silicon substrate, an alumina slurry is used with a concentrated slurry of alumina particles diluted in hydrogen peroxide solution added as an oxidizing agent. By supplying the slurry onto the semiconductor silicon substrate mounted on a CMP machine, the surface of the tungsten film and hydrogen peroxide are caused to undergo a chemical reaction to form a tungsten oxide film which permits easy polishing. The film formed by the reaction is polished by mechanical polishing between the alumina particles as a polishing abrasive and a polishing pad of the CMP machine such that the film is removed at unnecessary areas other than interconnecting lines.

As an apparatus and method for supplying a slurry to such a CMP machine as described above, it has been a common practice to mix a concentrated slurry, which contains a polishing abrasive chosen as desired, with an additives solution containing a surfactant, an oxidizing agent and the like and further, with diluting water, which may be used as needed, at a predetermined ratio in advance, and subsequent to temporary accumulation of the mixture in a storage tank, to supply the slurry to a CMP machine. These apparatus and method are, however, accompanied by a problem in that a slurry containing its components at a desired mixing ratio cannot be supplied adequately in a good form suitable for the polishing due to a deterioration in the polishing characteristics of the slurry and a reduction in the dispersibility of fine polishing particles in the slurry with time while being held in the storage tank after the mixing or due to low flexibility and applicability upon changing the mixing ratio of components which make up the slurry. With a view to coping with this problem, a slurry supplying apparatus has been proposed, for example, as disclosed in JP 2000-202774 A laid open to the public on Jul. 25, 2000. According to this slurry supplying apparatus, an aqueous solution of abrasive particles (concentrated slurry) and an additives solution are mixed together by a mixer shortly before they are injected against a polishing pad of a CMP machine, so that the plural solutions are supplied as a slurry.

According to an investigation by the present inventors, however, the slurry supplying apparatus disclosed in JP 2000-202774 A cited above has been found to involve problems as will be described next. The mixing accuracy of slurry components depends solely upon flowmeters and constant flow rate valves the openings of which are feedback controlled by the flowmeters, respectively. In each flowmeter, however, there is a substantial error especially in a low flow rate range when its accuracy is considered. In each constant flow rate valve, on the other hand, there is a concern about its clogging with a concentrated slurry. With such a construction as described above, a slurry may not be adequately supplied at a particular mixing ratio of its liquid components suitable for desired polishing in some instances. Furthermore, in the conventional apparatus described above, plural liquid components are fed by their corresponding pumps to the supplying apparatus. According to an investigation by the present inventors, the above-described system was found to have a difficulty in maintaining the mixing accuracy of liquid components in a slurry at high accuracy level because pulsations (pressure fluctuations) of the pumps employed there deleteriously affect the maintenance of constant flow rates at the constant flow rate valves. While a mixed solution remains unused, fine particles in the slurry may settle or agglomerated so that internal piping may be clogged. The above-described conventional apparatus, however, does not permit removal of such settled or agglomerated, fine particles because it is not equipped with any cleaning and flushing means for an area where mixing is performed. Especially in an initial stage after resuming supplying the slurry, a problem is considered to still remain unsolved in maintaining the accuracy of the mixing ratio.

### SUMMARY OF THE INVENTION

An object of the present invention is, therefore, to provide an apparatus for preparing and supplying a slurry to a CMP machine, which can supply the slurry at an optional flow rate suited for desired working or machining to the CMP machine, with its liquid components mixed together at a high-accuracy mixing ratio, in a good state free of any substantial deterioration, and in an appropriate and simpler manner.

Another object of the present invention is to provide a method for preparing and supplying slurries to plural CMP machines, respectively, which can supply the slurries at optional flow rates suited for desired working or machining operations to the CMP machines, with their liquid components mixed together at high-accuracy mixing ratios, in good states free of any substantial deterioration, and in an appropriate and simpler manner.

A further object of the present invention is to provide an apparatus for preparing and supplying a slurry, which can maintain the mixing ratio of its liquid components with high accuracy even in an initial stage after the supply of the slurry is resumed subsequent to a temporary halt.

The above-described objects can be achieved by the present invention which will be described hereinafter. Described specifically, the present invention, in one aspect thereof, provides an apparatus for preparing and supplying a slurry to a chemical mechanical polishing machine. The slurry contains liquid components, which comprise at least a dispersion of fine abrasive particles and a solution of an additive, at a predetermined mixing ratio. The apparatus includes draw ports for separately drawing therethrough the liquid components, said draw ports corresponding in number to the liquid components; a discharge port for supplying the slurry to the chemical mechanical polishing machine; feed pumps arranged on feed lines for the liquid components, respectively, said feed lines extending from the individual draw ports to the discharge port, such that the feed pumps can draw the corresponding liquid components in specific amounts to give the mixing ratio and can deliver the thus-drawn liquid components toward the discharge port, respectively; dampers and pressurization valves arranged in combinations on the respective feed lines on delivery sides of the feed pumps; flowmeters arranged on the respective feed lines on downstream sides of the corresponding combinations of the dampers and pressurization valves for measuring delivery rates from the corresponding feed pumps; and a programmable logic controller for controlling delivery rates of the individual feed pumps by using measurement values from the flowmeters. In a preferred embodiment, the present invention also provides an apparatus as described above, in which the programmable logic controller performs PID control by using differences of measurement values of the respective flowmeters from predetermined flow rates preset for delivering the liquid components in specific amounts by the feed pumps, respectively, and also control to follow up changes in the predetermined flow rates.

In another aspect of the present invention, there is also provided a method for preparing and supplying, to plural chemical mechanical polishing machines, slurries at flow rates and with compositions as required by the chemical mechanical polishing machines. The method includes connecting slurry preparing and supplying apparatuses of the above-described construction to the chemical mechanical polishing machines respectively, such that the liquid components, which comprise at least the dispersion of fine abrasive particles and the solution of the additive, can be parallelly supplied to the individual chemical mechanical polishing machines via the corresponding slurry preparing and supplying apparatuses. In another preferred embodiment, the present invention also provides a method as described above, which further includes inputting from the individual chemical mechanical polishing machines to the programmable logic controller information on predetermined amounts of the individual liquid components required by the chemical mechanical polishing machines, respectively; monitoring for changes in the predetermined amounts; and performing control of delivery rates from the respective feed pumps by using differences of measurement values of the flowmeters from the predetermined amounts.

The slurry preparing and supplying apparatus and method according to the present invention can supply a slurry at an optional flow rate suited for desired working or machining to a CMP machine, with its liquid components mixed together at a high-accuracy mixing ratio, in a good state free of any substantial deterioration, and in an appropriate and simpler manner. The apparatus and method according to preferred embodiments of the present invention can maintain the mixing ratio of the liquid components of a slurry with high accuracy even in an initial stage after a supply of the slurry is resumed subsequent to a temporary halt.

### BRIEF DESCRIPTION OF THE DRWINGS

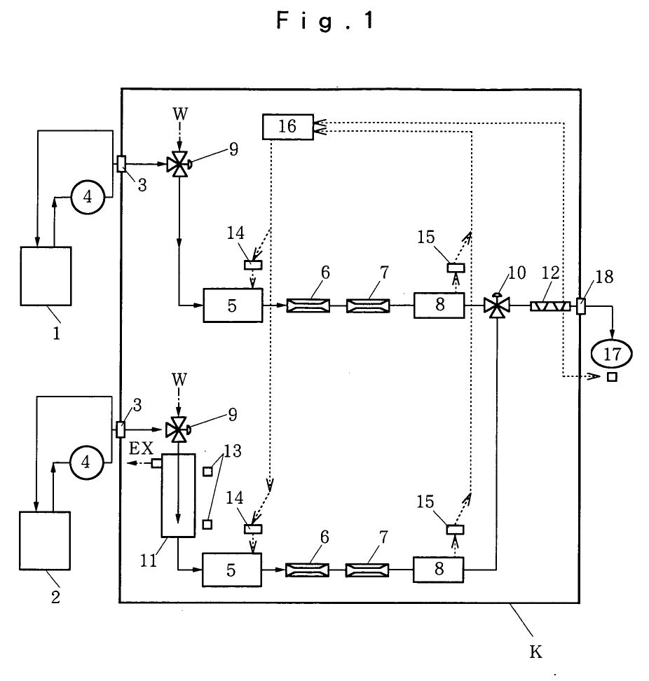

FIG. 1 is a schematic view of a slurry preparing and supplying apparatus according to one embodiment of the present invention.

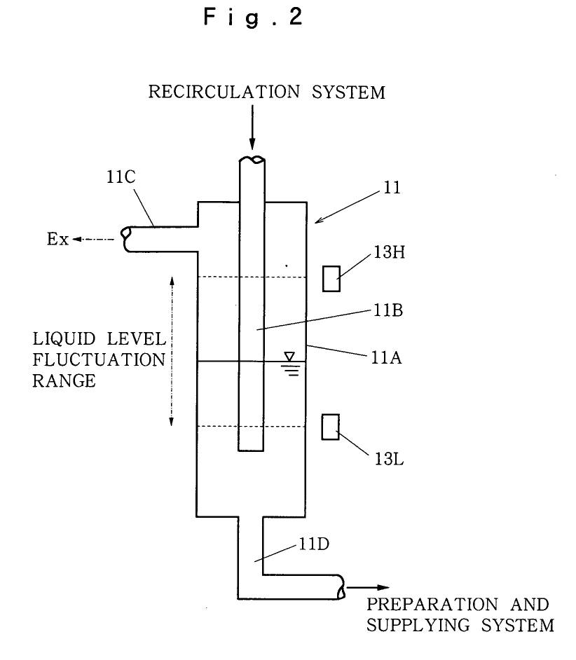

FIG. 2 is a schematic cross-sectional view of an isolator used in the apparatus of FIG. 1.

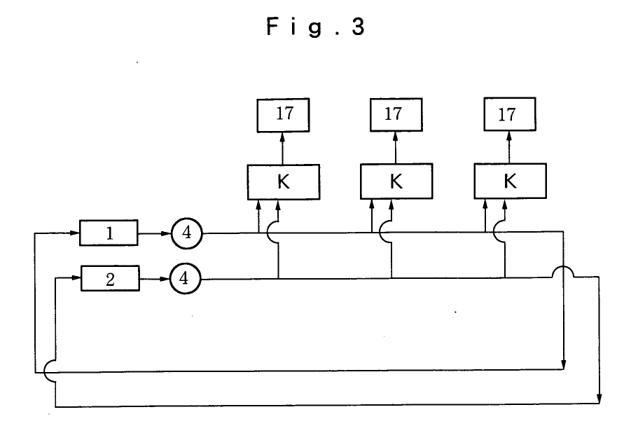

FIG. 3 is a schematic construction diagram illustrating an application of the apparatus of FIG. 1 to plural CMP machines.

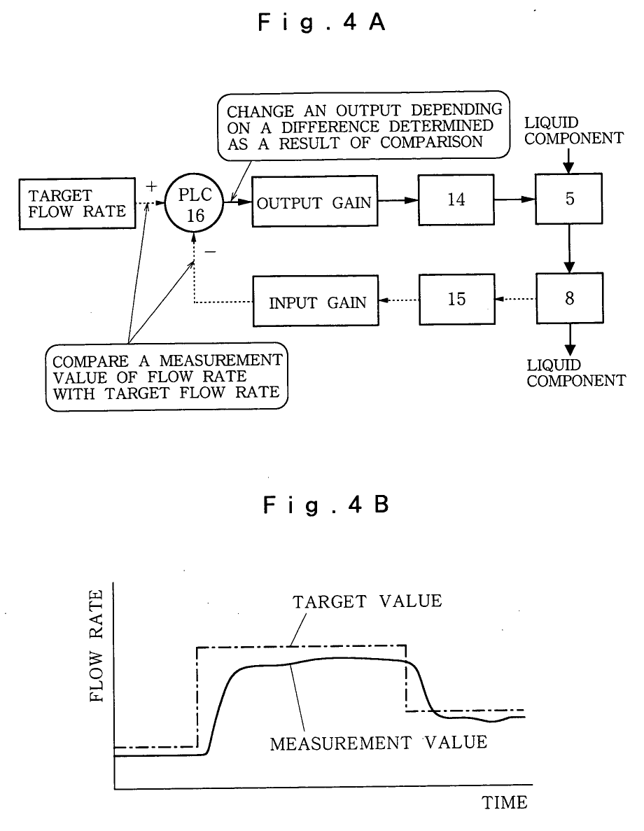

FIG. 4A is a block diagram of a first control system usable in the apparatus of FIG. 1.

FIG. 4B is a graph of a delivery rate of a liquid component as a function of time when the corresponding feed pump is controlled by the control system of FIG. 4A.

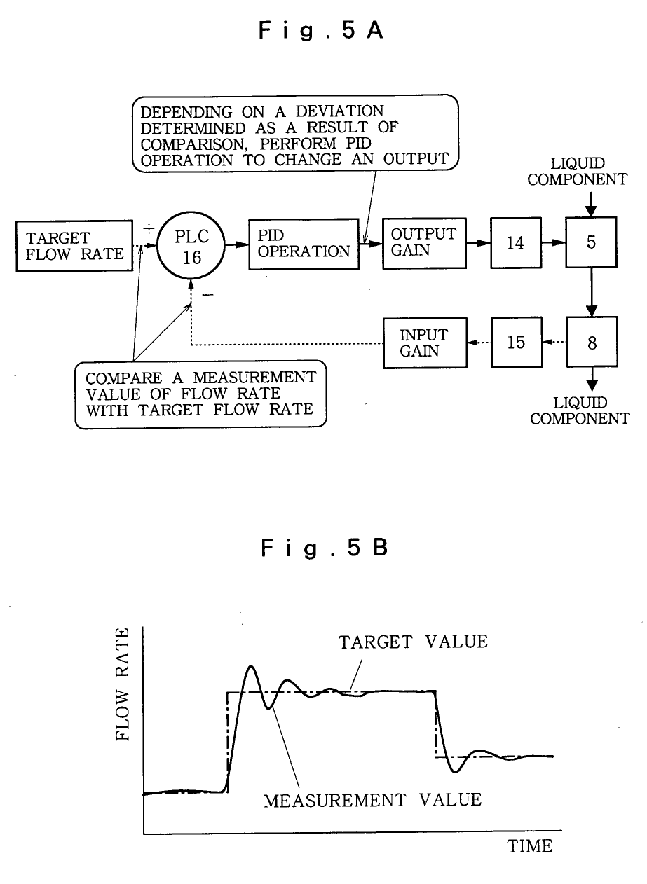

FIG. 5A is a block diagram of a second control system usable in the apparatus of FIG. 1.

FIG. 5B is a graph of a delivery rate of a liquid component as a function of time when the corresponding feed pump is controlled by the control system of FIG. 5A.

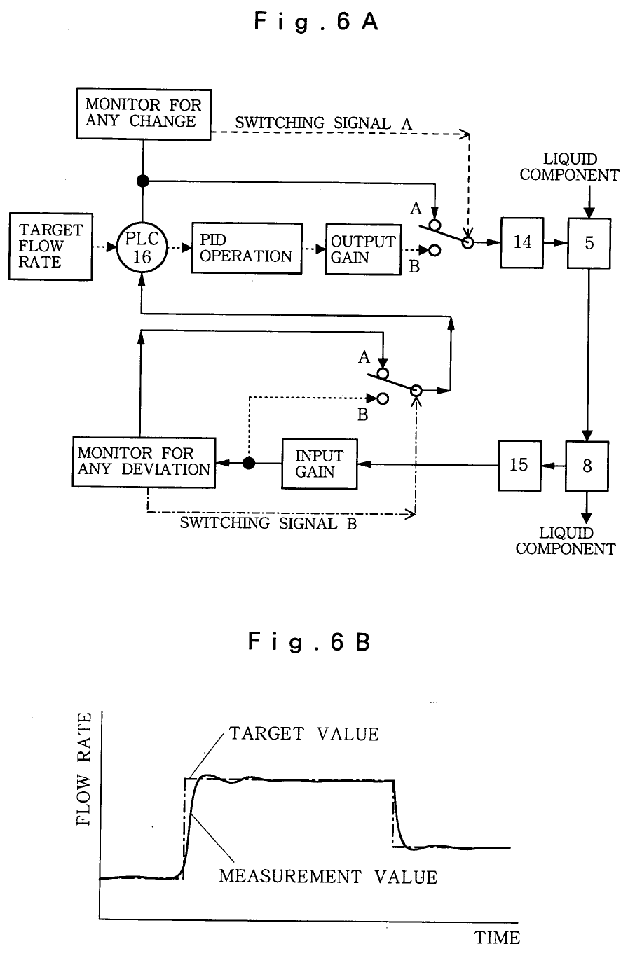

FIG. 6A is a block diagram of a third control system usable in the apparatus of FIG. 1.

FIG. 6B is a graph of a delivery rate of a liquid component as a function of time when the corresponding feed pump is controlled by the control system of FIG. 6A.

### DETAILED DESCRIPTION OF THE PREFERRED EMBODIMENTS

Based on the preferred embodiments and its modifications, the present invention will hereinafter be described in detail. With a view to solving the above-described problems of the conventional art, the present inventors conducted an extensive investigation. As a result, it was found that in some instances, a conventional slurry preparing and supplying apparatus, in which a concentrated slurry and an additives solution are mixed together shortly before they reach a CMP machine, may be unable to mix these liquid components at a high-accuracy mixing ratio and to supply the resulting slurry in a stable state. In view of this finding, it came to the present inventors' mind that the mixing ratio of liquid components, which includes at least a concentrated slurry and an additives solution, in a slurry would be successfully controlled with high accuracy if delivery rates of these liquid components from their corresponding feed pumps can be stabilized by developing a means for reducing to minimum levels fluctuations in the delivery rates of the liquid components from the pumps upon feeding them. The present inventors have then proceeded with an investigation, leading to the completion of the present invention.

According to the investigation by the present inventors, plural liquid components to be fed to their corresponding feed pumps have their own optimal pressure conditions, respectively, and delivery rate characteristics of the feed pumps firstly depend on pressure fluctuations of the individual liquid components under feeding. These pressure fluctuations include those attributable to pulsations produced when pumps or the like are used to feed the individual liquid components and those attributable to effects from use of the liquid components at other CMP machine(s). Interested in a finding that minimization of these pressure fluctuations can become useful means for minimizing fluctuations in the delivery rates of the liquid components from the corresponding feed pumps, the present inventors proceeded with developments. As a result, it has been found that use of such means makes it possible to feed a slurry to each CMP machine at a high-accuracy mixing ratio of its liquid components, in a good state free of any substantial deterioration and in an appropriate and simple manner, because at optional flow rates suited for polishing work desired at the CMP machine, the liquid components are fed from the corresponding feed pumps while being maintained at accurate delivery rates.

Firstly, one of such means is to minimize pulsations associated with feeding of each liquid component by its corresponding feed pump. This approach will be described based on FIG. 1, which shows an illustrative slurry preparing and supplying apparatus K according to one embodiment of the present invention. The slurry preparing and supplying apparatus K is of the two liquid components mixing type, and is used to mix two liquid components for the preparation of a slurry and to supply the slurry to a CMP machine 17. The drawing shows a drum 1 filled with a concentrated slurry (hereinafter called “the liquid component A”) containing fine abrasive particles such as silica, alumina or ceria dispersed in water in which a surfactant or the like is contained, and a drum 2 filled with an additives solution (hereinafter called “the liquid component B”) which is to be mixed with the liquid component A and contains additives such as a surfactant, an oxidizing agent and the like. Designated at numeral 4 are recirculation pumps for recirculating the liquid components A,B, respectively. As the recirculation pumps 4, conventional pumps such as diaphragm pumps can be used. In combination with the recirculation pumps 4, unillustrated dampers may be arranged to dampen pulsations.

In FIG. 1, the liquid component A fed from the drum 1 via a draw port 3 and the liquid component B fed from the drum 2 via a draw port 3 are mixed together such that these liquid components are supplied at desired specific flow rates to the CMP machine 17 via a discharge port 18. In the embodiment depicted in FIG. 1, the liquid component A and the liquid component B are both recirculated by the recirculation pumps 4. According to an investigation by the present inventors, it has been ascertained that pressure fluctuations, which are produced by delivery pressure and pulsations of each pump 4 itself, give an adverse effect on the accuracy of a delivery rate from the corresponding feed pump 5 and as a result, make it difficult to maintain an accurate delivery rate from the feed pump.

To cope with this problem, it may be contemplated to additionally arrange a correction system for these pressure fluctuations and to control delivery rates of the individual feed pumps 5. It has been found that good control is feasible by such a method. However, each feed pump 5 used in the apparatus K generally has its own delivery rate characteristics (individual difference). It is, therefore, required to prepare as many correcting operation expressions as the feed pumps to be used. Upon setting up the apparatus or replacing the feed pumps 5, operation expressions have to be prepared again. Irksome work may hence be needed in some instances. According to a still further investigation by the present inventors, the arrangement of such a correction system was found to involve a practical problem in that as conditions for permitting control, limitations are imposed on the maximum pressures of the individual liquid components to be introduced into the slurry preparing and supplying apparatus. Accordingly, there is still a room for improvements in the above-described correction system.

The present inventors, therefore, have proceeded with a still further investigation. As a result, it has been found that a slurry can be supplied to a CMP machine at a high-accuracy mixing ratio of its liquid components, in a good state free of any substantial deterioration and in an appropriate and simpler manner when flowmeters 8 are arranged on delivery-side feed lines of the individual feed pumps 5 to measure delivery rates from the individual feed pumps 5 and more preferably, when a programmable logic controller (hereinafter abbreviated as “PLC”) 16 capable of monitoring for changes in desired delivery rates preset and inputted in connection with the individual feed pumps 5 and performing output control to allow the feed pumps to sufficiently follow up the changes in the preset delivery rates and also PID control by use of deviations of delivery rates (current values) obtained by the flowmeters 8 from their corresponding preset delivery rates (preset values) is additionally arranged to permit control of delivery rates from the individual feed pumps 5, because the above-described constitution can feed the liquid components accurately at desired flow rates suited for a desired polishing operation. This constitution will hereinafter be described with reference to FIG. 1.

Using, as targets, desired feeding flow rates set beforehand at the preparing and supplying apparatus K or desired flow rate signals transmitted from the CMP machine 17 to the PLC 16, PLC 16 firstly transmits necessary flow rate signals to pump controllers 14 for the individual feed pumps 5. Each pump controller 14 processes the flow rate signal to convert it into a pump drive voltage so that the corresponding feed pump 5 is driven at a desired delivery rate. The flowmeter 8 arranged on the delivery-side feed line of each feed pump 5 measures an actual delivery rate of the liquid component from the feed pump 5.

Using a measurement value obtained by each flowmeter 8, the delivery rate of the corresponding feed pump 5 is controlled. As a premise for this control, the slurry preparing and supplying apparatus K according to this embodiment makes a flow of each liquid component delivered from its corresponding feed pump 5 stable without fluctuations by a method to be described next. Described specifically, each liquid component is delivered from its corresponding feed pump 5 and is supplied to the CMP machine 17. If pulsations of the feed pumps 5 propagate to their corresponding liquid components, an adverse effect is given on the stable supply of the slurry. To reduce such an adverse effect, this embodiment makes combined use of a damper 6 and a pressurization valve 7 on the delivery-side feed line of each feed pump 5. This constitution can significantly dampen pulsations of the individual feed pumps 5 so that the flows of the liquid components delivered from the respective feed pumps 5 and supplied toward the CMP machine 17 can be maintained in stable states.

Described specifically, the arrangement of each damper 6 can dampen pulsations of the corresponding liquid component caused by the associated feed pump 5. As a result, the liquid components delivered from their corresponding feed pumps 5 can be fed and mixed as stable flows. Further, the structure of each pressurization valve 7 employed in combination with its associated damper 6 is very close to the damper 6 and hence, the pressurization valve 7 is expected to have an effect to further dampen pulsations of the liquid component caused by the associated feed pump 5. As a result, the pulsations of the feed pumps 5 are significantly reduced, and therefore, the flows of liquid components delivered from the individual feed pumps 5 and supplied toward the CMP machine 17 are maintained stable to permit supplying a slurry at a high-accuracy mixing ratio of its liquid components.

In the present invention, a flow of each liquid component delivered from its corresponding feed pump 5 is maintained in a stable state by the adoption of the above-described delivery rate control system. Further, the delivery rates of the individual liquid components from these feed pumps 5 are continuously measured by the corresponding flowmeters 8 and more preferably, any changes in the preset values inputted as liquid amounts desired for the individual feed pumps 5 are also monitored. By using these delivery rates and changes, control is performed such that the individual liquid components are stably supplied at accurate delivery rates to the CMP machine. A description will hereinafter be made about this control.

As illustrated in FIG. 1, delivery rates of the individual liquid components from the corresponding feed pumps 5, said delivery rates being continuously measured by the flowmeters 8, are inputted to PLC 16 via their corresponding flowmeter detectors 15. Firstly, PLC 16 is designed to permit continuous monitoring for deviations of readings (measurement values) of the individual flowmeters 8 from the desired feed flow rates of the corresponding liquid components set in advance at the slurry preparing and supplying apparatus K or from the feed flow rates of the individual liquid components obtained based on the desired flow rate signals (these feed flow rates will hereinafter be collectively called “preset flow rates”) transmitted from the CMP machine 17 to PLC 16. The pump controllers 14 are feedback controlled using these deviations, respectively, such that the delivery rates from the individual feed pumps 5 are PID controlled to make them closer to the preset flow rates as targets. When these preset flow rates remain constant, it is sufficient to perform only this PID control. Where the desired preset flow rates are changed as occasion demands, however, it is difficult to perform control to fully follow up the changes if only the PID control is relied upon. In some instances, it may therefore take substantial time until the delivery rates are stabilized at the corresponding preset flow rates as the targets. This is believed to be attributable to the existence of cases in each of which depending on the feed pumps, their response speeds are too slow to sufficiently follow up the speed of the PID control. In the present invention, it is hence preferred to perform control by making combined use of output control of the feed pumps and the PID control as described above. As flowmeters usable for such control, those of the propagation time difference type making use of ultrasonic waves are preferred. Illustrative of such flowmeters is “USF200S” (tradename) manufactured by Tokyo Flow Meter Co., Ltd.

In the slurry preparing and supplying apparatus K according to this embodiment, the individual liquid components are drawn in desired amounts by the corresponding feed pumps 5 and are delivered and fed toward a mixer 12, as described above. During this time, pulsations caused by each feed pump 5 are lessened by its associated damper 6 and pressurization valve 7 such that the state of delivery of the liquid component from the feed pump 5 is stably maintained. Concurrently with this, the delivery rate control system composed of the flowmeters 8 and PLC 16 is used in combination to suppress any adverse effect on the accuracy of delivery rates of the feed pumps 5, said adverse effect occurring by pressure fluctuations caused especially by delivery pressures and pulsations of the recirculation pumps 4 themselves when the recirculation pumps 4 are used, so that control is performed to feed the individual liquid components accurately at the flow rates preset as targets, respectively. As a consequence, the slurry preparing and supplying apparatus K according to this embodiment, which makes use of the above-mentioned combination, can stably supply a slurry in a state free of any substantial deterioration to the CMP machine 17 while maintaining the mixing ratio of its liquid components with high accuracy. According to this embodiment, the above-described excellent effects can be achieved by the simple constitution that without arrangement of any complex correction system or control system, the flowmeters 8 are arranged on the outlet sides of the individual feed pumps 5 and the programmable logic controller 16 is arranged to control the delivery rates of the feed pumps 5 by using measurements values from the flowmeters 8.

In the embodiment depicted in FIG. 1, the liquid component A and the liquid component B are both recirculated by their corresponding recirculation pumps 4. However, the present invention is not limited to such a design, and these liquid components may be force fed without using pumps in some instances. According to an investigation by the present inventors, especially when the recirculation pumps 4 were used, pressure fluctuations caused by delivery pressures and pulsations of the recirculation pumps 4 themselves gave an adverse effect on the accuracy of delivery rates from the feed pumps 5. A tendency was, therefore, observed to the effect that delivery rates were not maintained accurately and the mixing ratio of the liquid components in the slurry was not successfully maintained with high accuracy. Especially in a combination with a system making use of the recirculation pumps 4, it is effective to perform the above-described control of delivery rates by the flowmeters 8 and PLC 16. Even when the liquid components are force fed to the feed pumps 5 without using the recirculation pumps 4, the arrangement of the above-described control system can of course achieve maintenance of accurate delivery rates from the supply pumps 5.

In the slurry preparing and supplying apparatus K of this embodiment, it is also preferred to arrange an isolator 11 between at least one of the draw ports 3 and its corresponding feed pump 5 as illustrated in FIG. 1. Adoption of this constitution is preferred especially for a non-settling, concentrated slurry or an additives solution which contains no abrasive. A description will next be made about this modification. As mentioned above, an adverse effect may be produced on the accuracy of delivery rates from the feed pumps 5 when the recirculation pumps 4 or the like are used. Expecting that the above-described drawback would be successfully lessened further if the system in which recirculation is performed by the recirculation pumps 4 (hereinafter called “the recirculation system”) and the system in which the preparation and supplying of a slurry are conducted (the preparing and supplying apparatus K; may hereinafter be called “the mixing system”) can be isolated from each other, the present inventors has proceed with a development of a device capable of achieving such an objective. As a result, use of an isolator having the structure shown in FIG. 2 has been found to be effective. Based on FIG. 2, the structure of the isolator 11 will be described next.

The isolator 11 is in the form of a double-walled cylinder constructed of an outer cylinder 11A and an inner cylinder 11B arranged inside the outer cylinder 11A. The outer cylinder 11A is provided at two locations with liquid level sensors for controlling liquid levels within the outer cylinder 11A. Designated at numeral 13H is a high level sensor, while indicated at numeral 13L is a low level sensor. In communication with the atmosphere, a vent 11C is also arranged at a location higher than the high level sensor 13H. Through a bottom part of the outer cylinder 11A, a feed line 11D is arranged in communication with the corresponding feed pump 5. A top wall of the outer cylinder 11A is arranged in an air-tight fashion, and the inner cylinder 11B is secured to the top wall in such a way that the former extends through the latter. An open lower end portion of the inner cylinder 11B, said lower end portion being arranged inside the outer cylinder 11A, is located on a lower side than the low level sensor 13L.

When the isolator 11 of the above-described construction is arranged between the draw port 3 and the feed pump 5 as illustrated in FIG. 1, the isolator 11 functions as will be described below and can isolate the recirculation system and the mixing system from each other, specifically on the side of the feed pump 5 onwards. As a result, it is possible to suppress adverse effects on the accuracy of a delivery rate of the feed pump 5, said adverse effects occurring by pressure fluctuations produced by delivery pressure and pulsations of the recirculation pump 4 itself employed in the recirculation system. It is, therefore, possible to further reduce effects of the recirculation system on the mixing system. A further description will be made with reference to FIG. 2. The liquid component to be fed from the recirculation system for the liquid component B, said recirculation system being provided with the recirculation pump 4, to the feed pump 5 via the draw port 3 is firstly introduced from the inner cylinder 11B into the outer cylinder 11A. As already mentioned in the above, the outer cylinder 11A is in communication with the atmosphere via the vent 11C so that in the isolator 11, the pressure of the liquid component B to be fed to the feed pump 5 is released into the atmosphere. As a consequence, the feed pump 5 draws the liquid component B which is stored in the isolator 11 and is in a non-pressurized state, and then delivers the same. Accordingly, the delivery rate of the feed pump 5 is controlled without being affected by pressure fluctuations on the primary side (especially, on the side of the recirculation system).

When plural slurry preparing and supplying apparatuses K are arranged in parallel with each other in communication with the recirculation lines of the individual liquid components to supply the individual liquid components to plural CMP machines 17 as illustrated in FIG. 3, concurrent operation of plural ones of the slurry preparing and supplying apparatuses K without any isolation between the recirculation system and the mixing system as in the conventional art leads to fluctuations in the pressures of the liquid components under recirculation on the primary side or the liquid components under force feeding by any one of the operated slurry preparing and supplying apparatuses K. These pressure fluctuations affect the pressures of the liquid components to the remaining slurry preparing and supplying apparatus(es) K in operation. As mentioned above, however, the recirculation system and the mixing system, especially on the sides of the feed pumps 5 and onwards, can be isolated from each other when the individual liquid components are designed to be drawn into the respective feed pumps 5 via isolators. This design can, therefore, cope with the above-mentioned problem.

No particular limitation is imposed on the material of the isolator 11 of the above-described construction insofar as it is excellent in chemical resistance and does not contaminate or otherwise deteriorate the individual liquid components. PFA (perfluoroalkoxyfluoroplastics), a fluorinated resin, or the like can be used, for example. As the liquid level sensors 13H, 13L of the isolator 11, on the other hand, use of capacitance sensors is preferred. Capacitance sensors manufactured by efector co., ltd. can be mentioned as commercially-available ones. It is, however, to be noted that the detection type of the sensors is not limited to the capacitance type and can be the photoelectric type or the like.

As a preferred modification of the above-described embodiment, the slurry preparing and supplying apparatus can be additionally provided with a cleaning and flushing system which makes it possible to clean and flush the feed line of the concentrated slurry with deionized water. This modification can solve the clogging problem of the piping in the slurry preparing and supplying apparatus due to settling and/or agglomeration of the abrasive during feeding standby, and can maintain high accuracy with respect to the mixing ratio of the liquid components in the slurry even in an initial stage after the feeding is resumed subsequent to a temporary halt. Although the above-described cleaning and flushing system may be operated manually with deionized water, it can be constructed as an automated cleaning and flushing system. Such an automated cleaning and flushing system further facilitates maintenance work.

In the slurry preparing and supplying apparatus according to this embodiment, the desired flow rates required for the CMP machine 17 can be inputted either directly to PLC 16 arranged in an main body of the slurry preparing and supplying apparatus K or by external transmission, which makes use of a network, from the CMP machine 17 to which the slurry is supplied. Adoption of the inputting method, which relies upon external transmission, makes it possible to perform remote control such that the supplying state of the slurry can be adequately controlled while observing the state of chemical mechanical polishing by the CMP machine 17. As a consequence, it becomes possible to make improvements in operability and also to achieve more perfect planarity on a work, for example, a substrate under polishing.

In the above description, the slurry preparing and supplying apparatus of the two liquid components mixing type was used to mix and supply two liquid components, that is, the liquid component A as a concentrated slurry and the liquid component B as an additives solution. However, the present invention is not limited to such a slurry preparing and supplying apparatus, but can mix and supply liquid components as many as needed. For example, a slurry preparing and supplying apparatus of the three liquid components mixing type can be constructed to mix and supply three liquid components by adding a system to feed deionized water in addition to the liquid component A and the liquid component B. This slurry preparing and supplying apparatus of the three liquid components mixing type can dilute and mix the liquid component A and the liquid component B with deionized water into appropriate forms, and moreover, can facilitate operation upon cleaning and flushing with deionized water the piping for the liquid component A as the concentrated slurry. As already mentioned in the above, the cleaning and flushing operation with deionized water can effectively solve the clogging problem of the piping in the slurry preparing and supplying apparatus due to settling and/or agglomeration of the abrasive during standby of slurry feeding. To modify the slurry preparing and supplying apparatus of the two liquid components mixing type shown in FIG. 1 into such a slurry preparing and supplying apparatus of the three liquid components mixing type as described above, it is only necessary to additionally provide a valve 9, which is arranged between the draw port 3 for the liquid component A and its corresponding feed pump 5, with an inlet for cleaning and flushing, deionized water W so that the inside of the piping for the liquid component A can be cleaned and flushed with the deionized water.

A description will hereinafter be made of specific flows of the individual liquid components in the slurry preparing and supplying apparatus K according to this embodiment. As illustrated in FIG. 1, the concentrated slurry as the liquid component A is firstly drawn by the recirculation pump 4 from the drum 1, delivered from the recirculation pump 4 and is returned back to the drum 1, so that the concentrated slurry is recirculated at a specific flow rate. Of the liquid components employed for the formation of the slurry, the concentrated slurry particularly involves the potential problem that the fine abrasive particles contained therein may settle. It is, therefore, preferred to feed it from the state of a recirculating flow to the feed pump 5 as illustrated by way of example in FIG. 1.

In the embodiment depicted in FIG. 1, a preset flow rate signal for the liquid component A from PLC 16 is converted into a drive voltage at the corresponding pump controller 14. Upon transmission of the drive voltage to the corresponding feed pump 5, the feed pump 5 is driven such that the liquid component A, which is recirculating at a predetermined flow rate, is fed to the feed pump 5 via the draw valve 3 and valve 9 and is then delivered at a preset, desired delivery rate from the feed pump 5. As illustrated in FIG. 1, adverse effects of pressure fluctuations in the recirculating flow of the liquid component A on the delivery rate of the liquid component A from the feed pump 5 during the above-described feeding are reduced as will be described below. Firstly, a delivery rate from the feed pump 5 is monitored by the flowmeter 8, and monitoring is continuously performed for any deviations of readings (measurement values) of the flowmeter 8 from the desired, preset flow rate which has been inputted in PLC 16 to perform PID control. More preferably, concurrent monitoring is also performed for any changes in the preset delivery rates of the individual feed pumps 5 to perform output control such that the poor responsibility of any feed pump(s) 5, which cannot follow up the PID control, can be complemented. Information controlled by these means are fed to the pump controllers 14 to perform control such that the outputs of drive voltages to the feed pumps 5 are precisely corrected to ensure the delivery of the liquid components at the accurate delivery rates from the feed pumps 5.

The liquid component A delivered stably at the specific flow rate from the feed pump 5 as described above is fed to the mixer 12 via the damper 6 and pressurization valve 7 arranged on the delivery-side feed line. Pulsations of the feed pump 5 are, therefore, dampened by these damper and pressurization valve so that adverse effects on the delivered flow, said adverse effects being caused by the pulsations, are reduced. The flows of the individual liquid components delivered from the corresponding feed pump 5 are hence maintained stable. As a consequence, a slurry with its liquid components mixed at a highly accurate ratio can be stably supplied to the CMP machine 17.

In the embodiment illustrated in FIG. 1, the liquid component B is also drawn by the corresponding recirculation pump 4 from the drum 2, delivered from the recirculation pump 4 and returned back to the drum 2 and hence, is recirculated at a specific flow rate, in a similar manner as the above-described recirculation of the liquid component A. Different from the concentrated slurry as the liquid component A, however, the additives solution as the liquid component B may be free of a potential problem such as settling depending on the kinds of the additives. It is, therefore, not absolutely necessary to recirculate the liquid component B by the recirculation pump 4. The liquid component B may thus be fed to the feed pump 5 by a force feed system without using any pump. Adverse effects of pressure fluctuations in the flow of the liquid component B by the recirculation or the force feed system on the delivery rate from the feed pump 5 can be eliminated in a similar manner as in the above-described case of the liquid component A, i.e., by arranging the flowmeter 8, PLC 16 and the pump controller 14 and controlling the delivery rate from the feed pump 5. Where the additives solution as the liquid component B does not have settling property, it is preferred to arrange the isolator 11 between the draw port 3 from the recirculation system of the liquid component B and the corresponding feed pump 5 as shown in FIG. 1. This construction can more stably maintain the flow of the liquid component delivered from the feed pump 5.

In the manner described above, the liquid components A and liquid component B are delivered from the corresponding feed pumps 5 at delivery rates accurately maintained with differences from the corresponding preset flow rates being reduced, and are also delivered in the form of flows maintained stable without being affected by pulsations of the feed pumps 5. These liquid component A and liquid component B are mixed together through a valve 10 and the mixer 12, and are supplied as a desired slurry to the CMP machine 17. The mixer 12 may be arranged as needed, although its arrangement is preferred to effectively conduct the mixing of plural liquid components. As a mixer usable for the above-mentioned purpose, a mixer manufactured by Noritake Company Limited or a like mixer can be mentioned.

The individual liquid components consisting of the liquid component A and the liquid component B are supplied to the CMP machine 17 as illustrated in FIG. 1 and also as described in the above. The individual liquid components, which have reached the valve 10, are at accurate flow rates reduced in difference from the corresponding preset flow rates, and moreover, are all in stable states free from effects of pulsations of the corresponding feed pumps 5. In the slurry formed as a mixture of these liquid components, the desired mixing ratio of the liquid components has, therefore, been achieved accurately.

As feed pumps for use in the present invention, constant flow rate pumps are preferred. As constant flow rate pumps, tubephragm pumps, bellows pumps or diaphragm pumps are generally used. It is preferred to use tubephragm pumps in the present invention. A tubephragm pump has merits that it is free from slurry flocculation and its own pulsations are smaller than those of other pumps. In a tubephragm pump, a liquid is alternately drawn in a specific amount into tubephragms, for example, two tubephragms and is alternately delivered from the tubephragms. The liquid is, therefore, delivered stably at a particular flow rate. To reduce effects of pulsations of each feed pump 5 on its corresponding liquid component delivered from the feed pump 5, this embodiment dampens the pulsations of the feed pump 5 by causing the liquid component to pass through the associated damper 6 and pressurization valve 7 subsequent to its delivery from the feed pump 5 as already mentioned in the above.

As dampers for use in the present invention, any dampers can be used insofar as they can dampen pulsations of the feed pumps 5 and can reduce adverse effects on the delivered liquid components. It is possible to use, for example, those of such a construction that the interior of each damper has the structure of a tubephragm, a fluid is caused to flow through the tubephragm, air of a predetermined pressure is introduced from the outside to compress the tubephragm inwards, and as a result, pressure fluctuations applied to the fluid upon its delivery from the feed pump 5 are dampened to reduce pulsations and to maintain a desired flow rate constantly.

As pressurization valves for use in the present invention, it is possible to use, for example, those of such an orifice construction that the interior of each pressurization valve has the structure of a tubephragm, a fluid is caused to flow through the tubephragm, air of a predetermined pressure is introduced from the outside to compress the tubephragm inwards, and a restriction can be effected on the pressure of the fluid on the primary side of a tubephragm pump so formed. Use of such a tubephragm structure is desired, because a damper effect can be expected and pulsations of the feed pump 5 can be more dampened than arrangement of the damper 6 alone.

In addition to the above-described damper effect, the use of the pressurization valve 7 can also bring about further advantageous effects especially as will be described below. Even when the recirculation system and the mixing system are isolated from each other by causing the interior of the above-described isolator to communicate with the atmosphere, certain small pressure fluctuations from the recirculation system, which have not been fully released into the atmosphere, are considered to give effects on the feed pump 5. In general, when a primary-side fluid which is to be drawn by a pump has a pressure, a situation called “fluid leak” occurs. As a consequence, there is a potential problem that this “fluid leak” may be added to a delivery rate to result in an error. This “fluid leak” can however, be prevented if a restriction is effected on (in other words, a back pressure is applied to) the fluid pressure on the primary side of the feed pump 5 by arranging the pressurization valve 7.

The present inventors next conducted an investigation about procedures for the feedback control of flow rates by PLC 16. As a result, it has been found that, as will be mentioned below, correction of a delivery rate from each feed pump by a combination of output control (a difference between a preset flow rate and a measurement value of the corresponding flowmeter) and proportional plus integral plus derivative control (hereinafter called “PID control”) is particularly preferred. A description will hereinafter be made about the investigated control procedures (A) to (C).

(A) Procedure Shown in FIG. 4A, in which a Delivery Rate from each Feed Pump is Corrected by Output Control Alone.

FIG. 4A shows a control flow for correcting each delivery rate by output control alone. According to this procedure, control is performed as will be described below.

(1) Amounts of the individual liquid components, which are required by the CMP machine 17, are inputted as preset flow rate values in PLC 16.

(2) PLC 16 outputs the preset flow rate values as flow rate signals to the corresponding pump controllers 14.

(3) The pump controllers 14 output drive voltages to the associated feed pumps 5.

(4) Flow rates of the liquid components actually delivered by the feed pumps 5 are measured by the associated flowmeters 8.

(5) Measurement values by the flowmeters 8 are inputted as flowmeter measurement values to PLC 16 via the corresponding flowmeter detectors 15.

(6) PLC 16 determines differences between the inputted preset flow rate values and the inputted flowmeter measurement values, and based on the differences, corrects the outputs of drive voltages to the feed pumps 5 via the corresponding pump controllers 14 such that flowmeter measurement values become closer to their corresponding preset flow rate values.

(7) The procedure is returned to the step (1).

As a result of performance of the above-described output control, it has been found that as illustrated in FIG. 4B, the difference between a preset flow rate value and a flowmeter measurement value may not be fully corrected in some instances by the control which directly corrects only the output of a drive voltage to the feed pump 5.

(B) Procedure Shown in FIG. 5A, in which a Delivery Rate from each Feed Pump is Corrected by PID Control Alone.

FIG. 5A shows a control flow for correcting each delivery rate by PID control alone. According to this procedure, control is performed as will be described below.

(1) Amounts of the individual liquid components, which are required by the CMP machine 17, are inputted as preset flow rate values in PLC 16.

(2) PLC 16 outputs the preset flow rate values as flow rate signals to the corresponding pump controllers 14.

(3) The pump controllers 14 output drive voltages to the associated feed pumps 5.

(4) Flow rates of the liquid components actually delivered by the feed pumps 5 are measured by the associated flowmeters 8.

(5) Measurement values by the flowmeters 8 are inputted as flowmeter measurement values to PLC 16 via the corresponding flowmeter detectors 15.

(6) PLC 16 determines deviations of the inputted flowmeter measurement values from the inputted preset flow rate values, and using the deviations, corrects the outputs of drive voltages to the feed pumps 5 via the corresponding pump controllers 14 such that flowmeter measurement values become closer to their corresponding preset flow rate values.

(7) The procedure is returned to the step (1).

As a result of performance of the above-described output control, it has been found that as illustrated in FIG. 5B, large overshoots and undershoots may occur in some instances relative to changes in the flow rate value preset as a target when the above-described correction of the output of a drive voltage to the feed pump 5 is performed by the output correction procedure making use of PID control alone. In other words, it has been found that errors in flow rate are very large and substantial time is required until the flow rate becomes stable. One of causes of such large overshoots and undershoots is presumably attributable to a failure of the pump response speed in following up the speed of the PID control due to the slow response characteristic of the feed pump when the flow rate varies considerably.

(C) Procedure Shown in FIG. 6A, in which a Delivery Rate from each Feed Pump is Corrected by the Combination of Output Control and PID Control.

FIG. 6A shows a control flow for correcting each delivery rate by the combination of output control and PID control. According to this procedure, control is performed as will be described below.

(1) PLC 16 continuously monitors for changes in the preset flow rate value as a target and also for deviations of measured flow rate values obtained by the flowmeter 8 from the preset flow rate value.

(2) When any change in the preset flow rate value as the target exceeds 5% per unit time, an input to PLC 16 is performed using a circuit A.

(3) PLC 16 outputs a flow rate signal to the pump controller 14.

(4) The pump controller 14 outputs a drive voltage to the feed pump 5.

(5) A flow rate of the liquid component actually delivered by the feed pump 5 is measured by the flowmeter 8.

(6) A measurement value by the flowmeter 8 is inputted as a flowmeter measurement value to PLC 16 via the flowmeter detector 15.

(7) When the deviation of a flowmeter measurement value from the preset flow rate value exceeds 5%, the circuit A is used. When this deviation returns to within 5%, switching to a circuit B is performed.

(8) When switched to the circuit B, PLC 16 determines a deviation of a flowmeter measurement value from the preset flow rate value inputted as the target and, while performing PID control, corrects an output such that the flowmeter measurement value becomes closer to the preset flow rate value.

(9) The procedure is returned to the step (1).

In the above description, 5% was used as a threshold for the switching of the circuit. It is, however, to be noted that another threshold, for example, 3% may be used. Further, it is also possible to set plural thresholds in advance such that an operator can choose suitable one of the thresholds depending on the details of the polishing work.

As a result of performance of the above-described output control, it has been confirmed that as illustrated in FIG. 6B, a delivery rate with a preset flow rate value realized very stably can be achieved. Described specifically, the flowmeter measurement value can be brought into closer conformity with the preset flow rate value when use is made of the control method by the combination of output control and PID control that, when a change takes is made to a flow rate value preset as a target, only the output of a drive voltage to the feed pump is directly changed as a first step to bring it closer to within 5% of the preset flow rate value and after confirmation of its achievement, the control is switched to PID control and a precise correction is performed in the switched state. As a result, the individual liquid components are supplied at accurate delivery rates to the CMP machine. By the correction procedure shown in FIG. 6A, the slurry preparing and supplying apparatus can maintain with high accuracy the mixing ratio of the liquid components in the slurry.

This application claims the priority of Japanese Patent Application 2002-263738 filed Sep. 10, 2002, which is incorporated herein by reference.

1. An apparatus for preparing and supplying a slurry to a chemical mechanical polishing machine, said slurry containing liquid components, which comprise at least a dispersion of fine abrasive particles and a solution of an additive, at a predetermined mixing ratio, comprising:
draw ports for separately drawing therethrough said liquid components, said draw ports corresponding in number to said liquid components;
a discharge port for supplying said slurry to said chemical mechanical polishing machine;
feed pumps arranged on feed lines for said liquid components, respectively, said feed lines extending from said individual draw ports to said discharge port, such that said feed pumps can draw the corresponding liquid components in specific amounts to give said mixing ratio and can deliver the thus-drawn liquid components toward said discharge port, respectively;
dampers and pressurization valves arranged in combinations on the respective feed lines on delivery sides of said feed pumps;
flowmeters arranged on said respective feed lines on downstream sides of the corresponding combinations of said dampers and pressurization valves for measuring delivery rates from the corresponding feed pumps; and
a programmable logic controller for controlling delivery rates of the individual feed pumps by using measurement values from said flowmeters.

2. An apparatus according to claim 1, further comprising at least one isolator arranged between one of said draw ports and its corresponding feed pump.

3. An apparatus according to claim 1, wherein said programmable logic controller performs PID control by using deviations of measurement values of said respective flowmeters from predetermined flow rates preset for delivering said liquid components in specific amounts by said feed pumps, respectively, and also control to follow up changes in said predetermined flow rates.

4. An apparatus according to claim 1, further comprising a feed line for feeding deionized water to said feed line for said dispersion of fine abrasive particles and a means for cleaning and flushing with the deionized water said feed line for said dispersion of fine abrasive particles.

5. An apparatus according to claim 1, further comprising a mixer arranged on said feed lines at a position between said individual flowmeters and said discharge port for performing mixing of said individual liquid components.

6. A method for preparing and supplying, to plural chemical mechanical polishing machines, slurries at flow rates and with compositions as required by said chemical mechanical polishing machines, which comprises connecting slurry preparing and supplying apparatuses as defined in claim 1 to said chemical mechanical polishing machines, respectively, such that said liquid components, which comprise at least said dispersion of fine abrasive particles and said solution of said additive, can be parallelly supplied to said individual chemical mechanical polishing machines via the corresponding slurry preparing and supplying apparatuses.

7. A method according to claim 6, further comprising:
inputting from said individual chemical mechanical polishing machines to said programmable logic controller information on predetermined amounts of said individual liquid components required by said chemical mechanical polishing machines, respectively;
monitoring for changes in said predetermined amounts; and
performing control of delivery rates from said respective feed pumps by using deviations of measurement values of said flowmeters from said predetermined amounts.
